(19) United States
(12) Patent Application Publication
(10) Pub. No.: US 2014/0355989 A1
(43) Pub. Date: Dec. 4, 2014

(54) SYSTEMS AND METHODS FOR PROVIDING BROADBAND COMMUNICATION

(71) Applicant: COX COMMUNICATIONS, INC., Atlanta, GA (US)

(72) Inventor: Jeffrey L. Finkelstein, Atlanta, GA (US)

(21) Appl. No.: 14/463,463

(22) Filed: Aug. 19, 2014

Related U.S. Application Data
(63) Continuation-in-part of application No. 13/109,529, filed on May 17, 2011.
(60) Provisional application No. 61/345,245, filed on May 17, 2010.

(51) Int. Cl. H04J 14/02

(52) U.S. Cl. CPC H04J 14/0232; H04J 14/0282
USPC 398/72

(57) ABSTRACT

Systems and methods for providing broadband communication are provided. An optical fiber node may be coupled to a source component. The optical fiber node may receive, from the source component, a downstream light signal via at least one input optical fiber, and transmit the downstream light signal to a plurality of output optical fibers. A tap device may be coupled to the optical fiber node via at least on optical fiber. The tap device may receive the downstream light signal via the at least one output optical fiber, convert the downstream light signal into a radio frequency downstream signal, and transmit the radio frequency downstream signal to a plurality of cable lines. The plurality of cable lines may be coupled to one or more customer premises.

### CROSS-REFERENCE TO RELATED APPLICATION

This application is a continuation-in-part of and claims the benefit of and priority to U.S. patent application Ser. No. 13/109,529, entitled “Systems and Methods for Providing Broadband Communication,” filed on May 17, 2011, which claims the benefit of U.S. Provisional Application No. 61/345,245, filed May 17, 2010, entitled “Systems and Methods for Providing Broadband Communication,” the disclosures of which are incorporated by reference herein in their entirety.

### FIELD OF THE DISCLOSURE

Aspects of the disclosure relate generally to broadband communication, and more particularly, to systems and methods that facilitate the provision of broadband communication.

### BACKGROUND OF THE DISCLOSURE

Cable service providers and other broadband service providers provide a wide variety of services to any number of customers or households. Examples of services that are provided include television service, telephone service, and Internet service. Typically, a cable service provider utilizes an infrastructure of fiber optic and radio frequency cables in order to communicate broadband signals to various customers and receive commands and other communications from the customers.

Within conventional cable infrastructures, a first frequency band is typically utilized for a forward data path or downstream data path and a second frequency band is typically utilized for a return data path or upstream data path. For example, a frequency band between eighty-eight (88) megahertz (MHz) and one (1) gigahertz (GHz) can be utilized to forward broadband communications from a cable plant to one or more households, and a frequency band between five (5) and eighty-five (88) MHz can be utilized to receive return signals from the one or more households. However, with increasing services being offered by cable providers and increasing bandwidth demands by customers, the existing return path likely will not have a sufficient data capacity to communicate return signals in a timely manner. In order to increase capacity, cable providers are typically required to install or add additional fiber nodes that are capable of providing service to their customers. Such installation often includes significant equipment costs.

Therefore, improved systems, methods, apparatus, and devices that facilitate the provision of broadband communication are desirable. Additionally, improved systems, methods, apparatus, and devices that provide increased return signal capability are desirable.

### BRIEF DESCRIPTION OF THE DISCLOSURE

Some or all of the above needs and/or problems may be addressed by certain embodiments of the disclosure. Embodiments of the disclosure may include systems and methods for providing broadband communication. In one embodiment, a system that facilitates the provision of broadband communication is provided. The system may include a source component, an optical fiber node, and a terminator. The source component may be configured to provide a downstream broadband signal to one or more customer devices and receive upstream signals from the one or more customer devices. The upstream signals may include a first signal having a frequency lower than the downstream broadband signal and a second signal having a frequency higher than the downstream broadband signal. The optical fiber node may be in communication with the source component via at least one optical fiber, and the optical fiber node may be configured (i) to receive the downstream broadband signal via the at least one optical fiber, (ii) convert the downstream broadband signal into a radio frequency downstream signal, (iii) output the downstream broadband signal onto one or more cable lines for communication to the one or more customer devices, (iv) receive the upstream signals via the one or more cable lines, and (v) convert the received upstream signals into light signals for communication to the source component via the at least one optical fiber. The terminator may be in communication with the optical fiber node via the one or more cable lines, and the terminator may be configured to output the radio frequency downstream signal for receipt by the one or more customer devices and direct the communication of the upstream signals to the optical fiber node via the one or more cable lines.

In accordance with another embodiment of the disclosure, a method for providing broadband communication is provided. A downstream broadband signal may be output by a source component for communication to a plurality of customer devices. Additionally, a first upstream signal having a frequency lower than the downstream signal may be received by the source component from a first customer device included in the plurality of customer devices. Additionally, a second upstream signal having a frequency higher than the downstream broadband signal may be received by the source component from a second customer device included in the plurality of customer devices.

Additional systems, methods, apparatus, features, and aspects may be realized through the techniques of various embodiments of the disclosure. Other embodiments and aspects of the disclosure are described in detail herein with reference to the description and to the drawings and are considered a part of the claimed disclosure.

### BRIEF DESCRIPTION OF THE DRAWINGS

Reference will now be made to the accompanying drawings, which are not necessarily drawn to scale, and wherein:

FIG. 1 illustrates a block diagram of an example system for providing broadband communication, according to an example embodiment of the disclosure.

FIG. 2 illustrates a block diagram of an example triplex gateway device that may be utilized in accordance with various embodiments of the disclosure.

FIG. 3 is a flow diagram of an example method for providing a broadband communication to a household, according to an illustrative embodiment of the disclosure.

FIG. 4 is a flow diagram of an example method for receiving a broadband communication from a household, according to an illustrative embodiment of the disclosure.

FIG. 5 is a block diagram of a system for distributing broadband communication using optical fibers, according to an illustrative embodiment of the disclosure.

FIG. 6 illustrates a block diagram of a gateway device for distributing broadband communication using optical fibers, according to an illustrative embodiment of the disclosure.

### DETAILED DESCRIPTION OF THE DISCLOSURE

Embodiments of the disclosure now will be described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

Embodiments of the disclosure may include systems, methods, apparatus, and devices for providing broadband communication. In certain embodiments, a cable infrastructure may be provided. The cable infrastructure may include a return signal data capacity that is relatively greater than that of conventional cable infrastructures. According to one example embodiment, a cable infrastructure may be provided that includes one or more additional return paths that facilitate the upstream communication of data from one or more households to a cable plant or cable source. According to an aspect of the disclosure, the additional return paths may have frequency bands or frequency ranges that are greater than those of conventional return paths and conventional forward paths. As one example, one or more additional return path signals having a frequency range within approximately 1.1 GHz and approximately 1.8 GHz may be utilized. Any number of return path signals may be provided that have a frequency range greater than that of the conventional forward path. In this regard, the cable infrastructure may include a relatively greater upstream data capacity than conventional cable infrastructures.

For purposes of this disclosure, the term “household” refers to any residential unit or business establishment that may be provided with broadband communication service, including but not limited to, houses, apartment units, condominium units, small businesses, etc.

I. Structural Overview

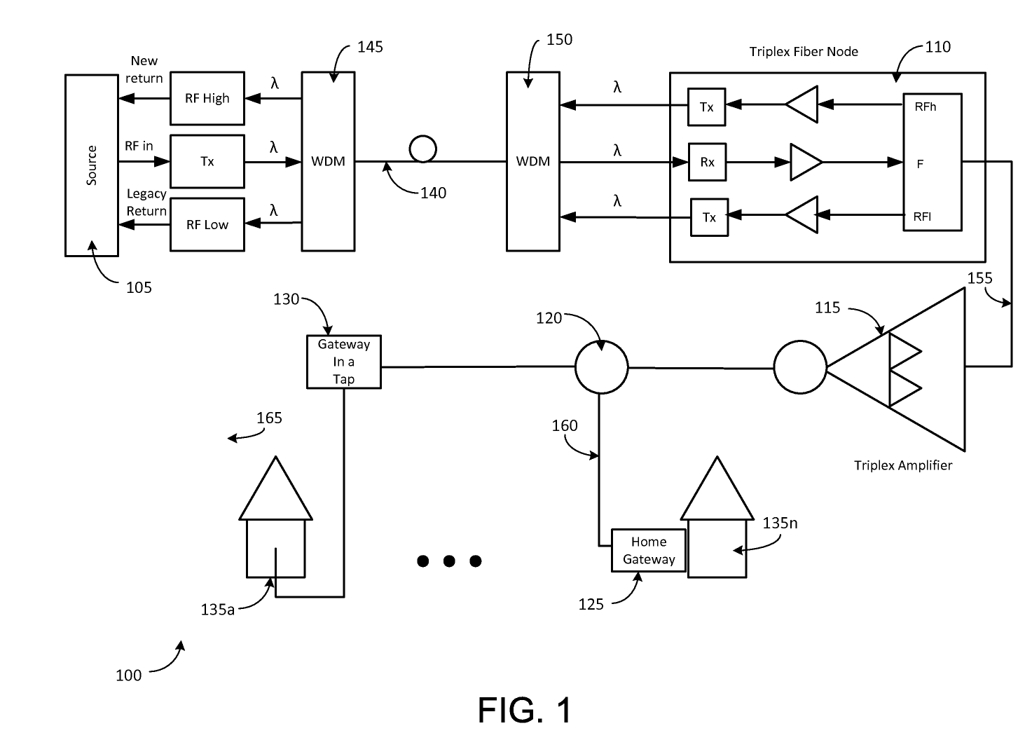

A first example system 100 or infrastructure for providing broadband communication will now be described illustratively with respect to FIG. 1. The system 100 may include a source 105, one or more fiber nodes 110, one or more amplifiers 115, one or more terminators 120 or taps, and one or more gateway devices 125, 130. The source 105 may be configured to output broadband communications for delivery to one or more of the gateway devices 125, 130. Additionally, a gateway device 125, 130 may be configured to output commands and/or other signals for communication to the source 105. According to an aspect of the disclosure, signals or communications that are output by a gateway device 125, 130 may be communicated to the source 105 utilizing at least one of two separate return paths or return bands. In this regard, relatively greater upstream data capacity may be provided by the system 100.

With reference to FIG. 1, the source 105 may be a suitable source of broadband content, such as a cable plant. The source 105 may be configured to generate and/or combine any number of data streams and/or data components into a broadband signal that is output by the source 105 for receipt by one or more households. For example, the source 105 may be configured to obtain video data streams from one or more content providers, such as television networks, premium content providers, and/or other content providers, and the source 105 may be configured to generate a broadband signal based at least in part on the video data streams. As desired, the source 105 may insert commercials and/or other data into a television or video component of a broadband signal. Additionally, the source 105 may be configured to generate or obtain any number of data components that are inserted or added to a broadband signal, such as television guide data, an Internet data signal, home security data signals, Voice over Internet Protocol (“VoIP”) telephone signals, etc. Any number of modulation techniques and/or data standards may be utilized by a source 105 in the generation or compilation of a broadband data signal. For example, television data may be modulated utilizing a suitable Quadrature Amplitude Modulation (“QAM”) or other modulation technique, and the modulated data may be incorporated into the broadband data signal. As another example, an orthogonal frequency-division multiple access (“OFDMA”) technique, a time division multiple access (“TDMA”) technique, an advanced time division multiple access (“ATDMA”) technique, a synchronous code division multiple access (“SCDMA”) technique, or another suitable modulation technique or scheme may be utilized to modulate data included within the broadband data signal. The broadband data signal may be configured to provide a wide variety of services to one or more households, including but not limited to, television service, telephone service, Internet service, home monitoring service, security service, etc.

Once a broadband data signal has been generated by a source 105, the source 105 may output the broadband data signal for communication to and receipt by one or more households, such as households 135a-n. In certain embodiments of the disclosure, the broadband data signal may be generated as a radio frequency (“RF”) signal in which the data components will be communicated to the households 135a-n utilizing a forward or downstream path. As desired, the forward path may include signal components having a frequency within a given forward path frequency range or frequency band. A wide variety of frequency ranges may be utilized as desired for the forward path, such as a frequency range from approximately eighty-eight (88) MHz to approximately one (1) GHz.

In certain embodiments, the generated broadband signal may be output utilizing one or more fiber optic cables 140 or optical fibers that are configured to carry the broadband signal from the source 105 to one or more corresponding fiber nodes 110. For example, the radio frequency broadband signal may be processed utilizing one or more suitable wavelength-division multiplexing (“WDM”) devices 145 or WDM systems, and the processed signal may be provided to or driven onto an optical fiber 140. A wide variety of different types of WDM devices 145 may be utilized as desired in various embodiments of the disclosure, such as dense WDM devices and add-drop WDM devices. As desired, a WDM device 145 may include a terminal multiplexer component that includes one or more wavelength converting transponders. Each wavelength converting transponder may receive one or more components of the input broadband signal and convert that signal into a light signal using a suitable laser, such as a 1550 nm band laser. The terminal multiplex may also contain an optical multiplexer configured to receive the various 1550 nm band signals and place or drive those signals onto a single optical fiber 140.

As desired, the WDM device 145 may amplify the broadband signals that are processed by the WDM device 145. Additionally or alternatively, one or more line repeaters or other amplifying devices may be positioned along a length of the optical fiber 140 in order to amplify the broadband signal and compensate for any losses in optical power.

In addition to processing downstream or forward path signals that are received from the source 105, the WDM device 145 may be configured to receive and process upstream signals that are communicated to the source 105 from one or more households 135a-n. In order to facilitate the processing of upstream or return path signals, the WDM device 145 may include one or more terminal demultiplexers that are configured to break a received signal back into individual signals that can be converted into radio frequency signals for provision to the source 105. According to an aspect of the disclosure, the WDM device 145 may include at least one terminal demultiplexer that is configured to process low frequency return path signals and at least one additional terminal demultiplexer that is configured to process high frequency return path signals. As desired, the return path signals that are processed may include a wide variety of different wavelengths. For example, the return path signals may include wavelengths of approximately 1310 nm and/or approximately 1570 nm. In certain embodiments, different wavelengths can be utilized for relatively high frequency return path signals and relatively low frequency return path signals.

The optical fibers 140 may be configured to carry broadband signals between the source 105 and one or more fiber nodes 110. These signals may include forward path signals generated by the source 105 and return path signals generated by one or more households 135a-n. For example, the optical fibers 140 may carry signals between a WDM device 145 associated with the source 105 and one or more WDM devices 150 associated with the fiber nodes 110. A wide variety of different optical fibers 140 may be utilized as desired in various embodiments of the disclosure, such as multi-mode fibers, single-mode fibers, and special purpose fibers. Additionally, the optical fibers 140 may be constructed from a wide variety of different materials, such as silica, fluorides, phosphates, and/or chalcogenides. The optical fibers 140 may be configured to carry signals as light pulses utilizing total internal reflection.

With continued reference to FIG. 1, any number of fiber nodes 110 may be provided. Each fiber node 110 may be configured to receive and process downstream or forward path signals from the source 105. Additionally, each fiber node 110 may be configured to receive and process upstream or return path signals received from the one or more households 135a-n. In certain embodiments of the disclosure, one or more of the fiber nodes 110 may be triplex fiber nodes that are configured to process three signals, including a relatively low frequency return path signal, a forward path signal, and a relatively high frequency return path signal. As desired, a fiber node 110 may filter one or more received signals utilizing physical or hardware filters and/or software-based filters in order to separate forward path and different return path signals for processing. For example, a high pass filter may be utilized to filter out a relatively high frequency return path signal, a band pass filter may be utilized to filter out a forward path signal, and a low pass filter may be utilized to filter out a relatively low frequency return path signal. In certain embodiments, each fiber node 110 may include or be in communication with a suitable WDM device 150. The WDM device 150 associated with the fiber node 110 may be similar to the WDM device 145 associated with the source 105 that is described above. However, the WDM device 150 associated with the fiber node 110 may be configured to receive a forward path signal from an optical fiber 140 as a light signal that can be converted into an RF signal. Additionally, the WDM device 150 may be configured to receive upstream or return path signals as RF signals that can be converted into one or more light signals for communication onto an optical fiber 140. According to an aspect of the disclosure, the fiber node 110 and WDM device 150 may be configured to receive and process any number of return path signals. For example, both a relatively low frequency return path signal (e.g., a signal having a frequency between approximately 5 MHz and approximately 85 MHz) and one or more relatively high frequency return path signals (e.g., one or more signals falling within a frequency range of approximately 1.1 GHz to approximately 1.8 GHz or higher).

The fiber node 110 may output a received forward path signal onto one or more cable lines 155 as an RF signal. According to certain embodiments of the disclosure, up to four cable lines 155 may be connected to a fiber node 110; however, as desired, any number of cable lines 155 may be connected to the fiber node 110. Additionally, the fiber node 110 and the WDM device 150 may output a received return path or upstream signal onto the optical fiber 140 for communication to the source 105.

In certain embodiments, the fiber node 110 may be configured to amplify forward path and/or return path signals. For example, the fiber node 110 may include respective amplifiers or amplification components that are configured to amplify or enhance the forward signal, a relatively low frequency return path signal, and a relatively high frequency return path signal.

Each cable line 155 may be configured to communicate broadband signals or broadband communications between a fiber node 110 and one or more terminators 120 or taps that are connected to the cable line 155. A cable line 155 may be configured to communicate both forward path and return path broadband signals. A wide variety of suitable cable lines may be utilized as desired in various embodiments of the disclosure. For example, various types of coaxial cables and/or other RF cables may be utilized. Additionally, although a single cable line is discussed herein as being provided between a fiber node 110 and any number of terminators 120, it will be appreciated that any number of cable lines may be provided. For example, a first cable line may be provided between a fiber node and an amplifier, a second cable line may be provided between the amplifier and a first terminator, and a third cable line may be provided between the first terminator and a second terminator.

Any number of terminators 120 may be connected to a cable line 155 as desired in various embodiments of the disclosure. The terminators 120 may form access points from which households may be provided with broadband service. Each time a terminator 120 is connected to a cable line 155 and/or service is provided to a household, the strength of the broadband signal carried by the cable line 155 may be reduced or degraded. Accordingly, in certain embodiments of the disclosure, one or more amplifiers 115 or amplification devices may be provided that are configured to amplify, enhance, or boost the signals that are propagated through the cable lines 155.

An amplifier 115 may be configured to amplify both forward path or downstream signals and return path or upstream signals. According to an aspect of the disclosure, one or more of the amplifiers 115 that are utilized may be triplex amplifiers that are configured to process and amplify three signals, including a relatively low frequency return path signal, a forward path signal, and a relatively high frequency return path signal. However, amplifiers that are configured to process more than three signals may be utilized. As desired, an amplifier 115 may filter one or more received signals utilizing any number of suitable physical or hardware filters and/or software-based filters. In this regard, forward path signals and various return path signals may be separated for amplification and other processing. For example, a high pass filter may be utilized to filter out a relatively high frequency return path signal, a band pass filter may be utilized to filter out a forward path signal, and a low pass filter may be utilized to filter out a relatively low frequency return path signal. Once a signal has been filtered out or otherwise isolated by the amplifier 115, the amplifier 115 may amplify the signal. For example, the amplifier 115 may increase the amplitude of the signal. In certain embodiments, the various components of a broadband signal (e.g., low return path, forward path, high return path) may be amplified by respective amplification components of the amplifier 115. Each amplified signal may then be output onto or driven back onto the cable line 155 in a desired direction for the signal. As desired, any number of diodes or other suitable devices may be incorporated into the amplifier 115 in order to prevent or limit undesired leakage of an amplified signal in a direction from which the signal was received. For example, the amplifier 115 may receive a return path signal from a terminator 120 or other amplifier, the amplifier 115 may amplify the signal, and the amplifier may output the signal in an upstream direction towards the fiber node 110 and/or source 105 while limiting the output or leakage of the signal in a downstream direction.

The amplifier 115 may include a wide variety of gains as desired in various embodiments of the disclosure. Additionally, as desired, different gains may be utilized for different components of a broadband signal. In certain embodiments, the amplifier 115 may be powered by a received broadband signal, such as a received downstream signal. Additionally or alternatively, the amplifier 115 may be powered by one or more batteries and/or external power sources. In certain embodiments, the power requirements of the amplifier 115 may be based at least in part on the modulation technique(s) utilized in association with the broadband signals that are amplified. In one example embodiment, a relatively low power amplifier may be provided in association with an OFDMA modulation technique.

With continued reference to FIG. 1, any number of terminators 120 or taps may be connected to a cable line 155. A terminator 120 may form an access point from which one or more households, such as households 135a-n, may be provided with broadband services. Any number of households may be serviced by a terminator 120 as desired in various embodiments of the disclosure. For example, in certain embodiments, up to four households may be serviced by a terminator 120. As desired, a cable drop 160, 165 or other signal line (e.g., a coaxial cable or RF cable) may extend from the terminator 120 to a household 135a-n. In this regard, signals may be provided to and/or received from the household 135a-n.

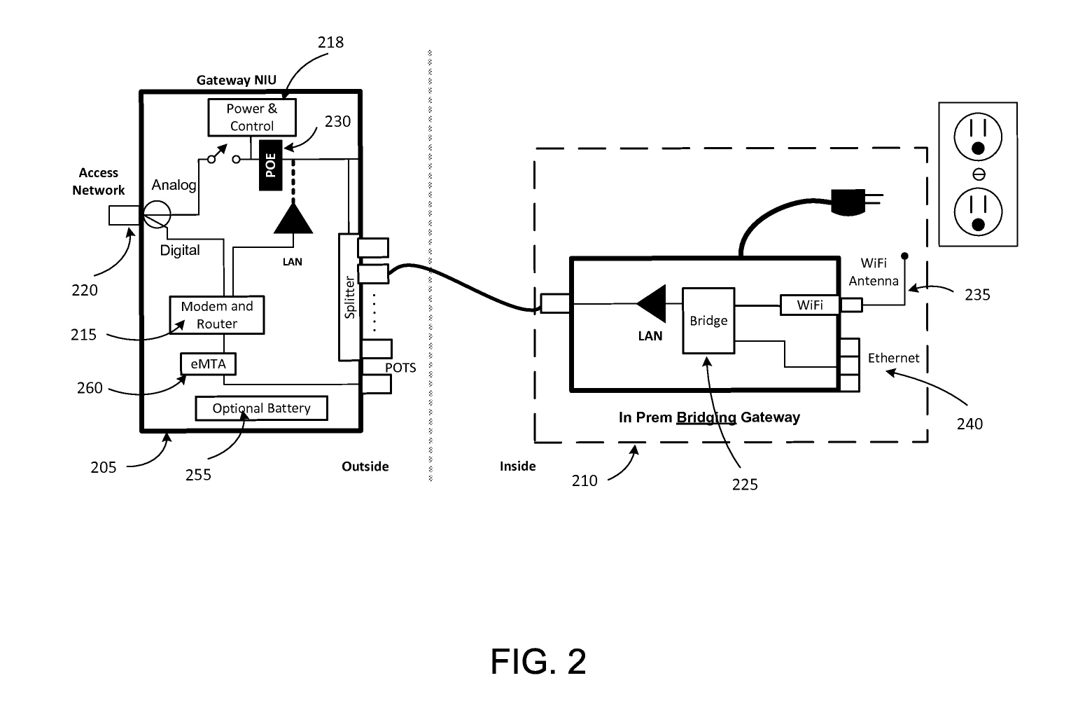

With continued reference to FIG. 1, a suitable gateway device may be configured to provide broadband services to a household. In certain embodiments of the disclosure, a home gateway device 125 may be provided for a household 135n. For example, a cable drop 160 may extend from a terminator 120 to a home gateway device 125, and the home gateway device 125 may provide service to the household 135n. As desired, a home gateway device 125 may be positioned within a household or just outside of a household, for example, on an external wall of a household. In other embodiments, a gateway device 130 may be incorporated into or situated at a terminator, and the gateway device 130 may process received broadband signals and provide broadband services to one or more households, such as household 135a. In other words, an outside hardened solution may be provided at the terminator 120 for providing any number of broadband services to households. An example of a suitable gateway device that may be incorporated into a terminator 120 is described in greater detail below with reference to FIG. 2.

A gateway device, such as a home gateway device 125 or a gateway device 130 that is included in a terminator, may include one or more components that control the provision of broadband services to one or more households. For example, a gateway device may include a broadband modem and/or a router that are configured to process received broadband signals and provide the signals to one or more households and/or to the source 105. In certain embodiments of the disclosure, a gateway device may be a triplex gateway device that is configured to process three signals, including a relatively low frequency return path signal, a forward path signal, and a relatively high frequency return path signal. However, gateway devices that are configured to process more than three signals may be utilized. In certain embodiments, a network, such as a local area network or a wide area network, may be formed between a gateway device and one or more devices situated within a household (e.g., set-top boxes, cable modems, routers, network bridging devices, etc.).

One example gateway device may include a face-plate or termination component, a cable device (e.g., a cable modem device or cable bridging device), and/or at least one Ethernet component. The face-plate or termination component may facilitate the termination of cable lines or cable drops that connect household devices to the gateway device and/or that connect the gateway device to a terminator or tap. A face-plate may be configured to pass broadband signals falling within an RF cable spectrum, such as broadband signals having a frequency of up to three (3) GHz. Additionally, the face-plate may include a relatively low loss direct current (“DC”) coupler that is configured to pass signals falling within the RF spectrum to the cable device. The cable device may be any suitable cable device that facilitates the filtering and processing of various components of one or more broadband signals, such as a relatively low frequency return path, a forward path, and a relatively high frequency return path. A wide variety of different types of cable devices may be incorporated into a gateway device as desired in various embodiments of the disclosure, such as broadband modems, multi-channel broadband modems, routers, and/or bridging devices. In certain embodiments, the cable device may be a suitable Digital Over Cable Service Interface Specification (“DOCSIS”) device (e.g., modem) that operates utilizing a DOCSIS telecommunications standard. The Ethernet component may include an Ethernet switching subsystem that connects an Ethernet output of a DOCSIS device to a switch fabric of a tap and/or an Ethernet bridge or other suitable Ethernet connection that translates Ethernet signals into signals that may be transmitted into a household. For example, the Ethernet component may include an Ethernet connection that is configured to connect to a Multimedia over Coax Alliance (“MoCA”) bridge or interface, although other interfaces and/or standards may be utilized. Utilizing MoCA interfaces, one or more MoCA signals may be output by the gateway device for communication to one or more households. A MoCA signal may be a signal that is allowed to be communicated to a household; however, the MoCA signal may be filtered by the Ethernet component and/or other components of the gateway device (e.g., any number of suitable MoCA filters or point of entry (“POE”) filters, etc.) in order to prevent leakage of the MoCA signal upstream to the source. In this regard, any home networks formed between the gateway device and one or more household routers may be isolated from the source.

The system 100 illustrated in FIG. 1 may provide one or more return paths or upstream paths having a frequency greater than that of a forward or downstream path. Accordingly, the various components of the system 100 may be configured to process at least one additional return path. In this regard, additional upstream data capacity and bandwidth may be provided to customers of a cable service provider.

FIG. 2 illustrates a block diagram of an example triplex gateway device 205 that may be utilized in accordance with various embodiments of the disclosure. The gateway device 205 of FIG. 2 may be a gateway device that is incorporated into a terminator or tap, such as the terminator 120 illustrated in FIG. 1. Alternatively, the gateway device 205 may be a gateway device that is situated external to a tap. The gateway device 205 may be a triplex gateway device that is configured to provide broadband signals to a household 210 and/or to receive broadband signals and/or data commands from the household 210.

As illustrated in FIG. 2, the gateway device 205 may include a modem/router 215 and a termination component 220. The termination component 220 may be configured to connect to a source of a broadband data signal and receive the signal from the source. For example, the termination component 220 may be configured to connect to a feeder of a broadband data signal, such as a feeder line provided by a cable company. In certain embodiments, the gateway device 205 may be situated at and/or within a cable junction box or tap, and a cable line or feeder may connect to the termination component 220 at the junction box. In other embodiments, a cable drop may be provided between a tap and the gateway device 205. A wide variety of suitable termination components 220 may be utilized as desired in various embodiments of the disclosure, such as a radio frequency (“RF”) termination component or an RF coaxial termination component.

Once a forward path or downstream broadband data signal is received by the termination component 220, the termination component may provide at least a portion of the received signal to the modem/router 215. For example, one or more components of the broadband data signal that carry modulated digital data may be provided to the modem 215. As explained in greater detail below, in certain embodiments, one or more analog components of the signal and/or unencrypted digital components of the signal (e.g., clear quadrature amplitude modulation (“QAM”) components) may be provided from the termination component 220 to one or more ports for provision to the household 210. When an upstream or return path signal is received by the termination component 220, the termination component 220 may provide and/or drive the upstream signal onto a feeder or cable line for communication to a source, such as the source 105 illustrated in FIG. 1.

In certain embodiments of the disclosure, the termination component 220 may receive a power signal from a cable drop or cable line. For example, a power signal may be received via a coaxial cable connected to the gateway device 205. As desired, the received power signal may be provided by the termination component 220 to one or more other components of the gateway device 205, such as the modem/router 215. In this regard, components of the gateway device 205 may be powered by the source of the broadband data signal. Alternatively, the gateway device 205 may be powered via a power bridge connected to a household. For example, the service gateway 205 may be powered via a power bridge connected to a power outlet or other power source at a household.

The modem/router 215 may be a combination device or two separate devices that are incorporated into or included in the gateway device 205. The modem/router 215 may be configured to receive a broadband data signal and provide at least a portion of the received broadband data signal to the household 210. As desired, the modem/router 215 may include one or more processing devices that may be configured for processing a received broadband signal and providing at least a portion of the broadband signal to the household 210. In this regard, the services provided to the household 210 may be controlled. Additionally, the processing devices may be utilized to control the general operations of the gateway device 205 and/or facilitate control of one or more of the other components of the gateway device 205. Additionally or alternatively, additional processing devices and/or control units, such as a controller 218 may be included. A processing device or processing component (e.g., the modem/router 215, controller 218, etc.) may be configured to access and read associated computer-readable media having stored thereon data and/or computer-executable instructions for providing broadband services to the household. The gateway device 205 of FIG. 2 is described as providing service to a single household 210; however, the functionality of the gateway device 205 may be extended in order to provide service to multiple households.

The modem/router 215 may include a suitable broadband modem component and/or a suitable router component. The modem component may be any suitable device that is configured to receive at least a portion of a broadband data signal from the termination component 220 and demodulate the received signal. Additionally, the modem may be configured to selectively output the broadband data signal and/or portions of the broadband data signal for receipt by one or more households, such as household 210. As desired, the modem component may be capable of providing a wide variety of services to a household, such as television service, Internet service, Voice over Internet Protocol (“VoIP”) telephone service, home monitoring services, etc. In certain embodiments, the modem component may divide and/or filter the received signal into one or more frequency bands associated with different services. Additionally, as desired, the modem component may selectively decrypt the received signal.

A wide variety of different types of broadband modem components or modems may be utilized as desired in various embodiments of the disclosure, including but not limited to, cable modems, passive optical network (“PON”) modems, and the like. In certain embodiments, the modem component may be a DOCSIS modem that operates utilizing a DOCSIS telecommunications standard. Additionally, as desired, the modem component may be a multi-channel modem that is capable of providing a signal to multiple households. The modem component may include any number of channels as desired in various embodiments, such as four channels, eight channels, etc. Additionally, each of the households and/or devices situated within the household (e.g., bridging devices, set-top boxes, etc.) may be individually addressable by the modem component. In this regard, the modem component may selectively provide portions of the broadband signal to one or more households.

Additionally, in certain embodiments, the modem component or another processing device associated with the gateway device 205 may control the provision of signals that are not processed by the modem component, such as analog signals, clear QAM signals, etc., to one or more households. For example, the modem component may control the positioning and/or actuation of one or more switches that facilitate the communication of an analog signal from the termination component 220 to one or more ports. In this regard, if a household 210 is not authorized to receive an analog signal, then the modem component may prevent the signal from being provided to the household 210. Accordingly, services (e.g., analog services, clear QAM services, digital services, etc.) may be selectively activated and deactivated for the household. In certain embodiments, control signals and/or configuration files may be uploaded or otherwise communicated to the modem component from the source 105, and the modem component may utilize the received information to selectively control the provision of services.

If a router component is provided, the router component may receive the broadband data signal (or a portion thereof) from the modem component, and the router component may output the broadband data signal for receipt by one or more remote devices situated within one or more households. The router component may be a specialized computer or computing component that facilitates the receipt of information from the modem component and the forwarding of received information to one or more households. Additionally, the router component may facilitate the receipt of upstream signals from one or more households and the provision of an upstream signal to the modem for communication to the source 105. A wide variety of suitable routers may be utilized as desired in various embodiments of the disclosure. Additionally, as desired, the router component may be a multi-channel router that facilitates communication with multiple households. The router component may include any number of channels as desired in various embodiments, such as four channels, eight channels, etc. In certain embodiments, the router component may be a router that includes one or more MoCA interfaces, although other interfaces and/or standards may be utilized. Utilizing MoCA interfaces, one or more MoCA signals may be output by the router component for communication to one or more households. A MoCA signal may be a signal that is allowed to be communicated to a household 210; however, the MoCA signal may be filtered by the router component and/or any number of suitable MoCA filters or point of entry (“POE”) filters 230 in order to prevent leakage of the MoCA signal onto a cable feeder and/or to the source. In this regard, a home network formed between the router component and a household 210 may be isolated from the source.

As desired, the router component may include a wireless output component. For example, the router component may form a wireless access point that facilitates access to broadband communication via any number of wireless devices or Wi-Fi devices. In certain embodiments, devices that are permitted to access certain portions of the broadband signal, such as mobile devices and/or computers associated with a household 210, may be configured to receive a wireless signal from the router component.

In operation, the router component may output a signal for receipt by a household 210 via a local area network (“LAN”) that is formed between the router and the household 210. In embodiments in which multiple households are serviced, a separate LAN may be provided for each respective household. Each LAN may be associated with a corresponding port that facilitates output of a broadband signal from the router component to the respective household. The ports may additionally facilitate the communication of analog components, clear QAM components, and/or other components of the broadband signal to the households. Additionally, as desired, certain ports may not be connected to a household, thereby leaving a household without service and/or providing resources to expand the services provided by the gateway device 205. Moreover, in certain embodiments, the gateway device 205 may provide conventional or legacy services to any number of households. For example, legacy services that bypass the functionality of the modem/router 215 (e.g., television service, etc.) may be provided to one or more households.

According to an aspect of the disclosure, the modem component and/or the router component may be configured to process forward path signals and multiple return path or upstream signals, such as a relatively low frequency return signal and at least one relatively high frequency return signal. The modem and/or router components may be configured to filter received signals in order to identify the type of signal that is received. Alternatively, separate filters may be utilized prior to a signal being provided to a modem and/or router. Once a signal has been received, the modem and/or router may identify a destination of the signal (e.g., a source, a household device, etc.) and direct the output of the signal to an identified destination.

Any number of suitable household devices may be in communication with the modem/router 215 of the gateway device 205. As shown in FIG. 2, a network bridging device 225 situated within the household 210, such as a Wi-Fi bridging device or other suitable bridging device, may be configured to receive a broadband signal from the service gateway 205. The network bridging device 225 may receive a broadband signal and provide the signal to one or more other household devices, such as a set-top box, personal computer, security system, etc. Additionally, the network bridging device 225 may receive commands and or upstream signals from the one or more household devices and provide the upstream signals to the modem/router 215. As desired, the network bridging device 225 may include or be in communication with a suitable transceiver component or wireless output component, such as a WiFi antenna 235. Additionally, as desired, the network bridging device 225 may be configured to provide a portion of the broadband signal to any number of Ethernet devices 240 or other suitable devices in communication with the network bridging device 225.

With continued reference to FIG. 2, any number of batteries 255 may be incorporated into the gateway device 205. The batteries 255 may be utilized to provide power to one or more components of the gateway device 205 in the event of a loss of power or low power event. In certain embodiments, the batteries 255 may be charged by a suitable power source prior to the detection of a loss of power event and/or following the end of a loss of power event.

With continued reference to FIG. 2, the gateway device 205 may include an embedded Multimedia Terminator Adaptor (“eMTA”) 260 in certain embodiments of the disclosure. An eMTA 260 may be provided in order to extend the functionality of the modem component to provide telephone service to one or more households. As desired, the eMTA 260 may be a multi-line eMTA. The eMTA 260 may facilitate the provision of VoIP telephony to one or more households. VoIP services may be provided to the households via the respective LANs and/or via any number of suitable plain old telephone service (“POTS”) ports and/or connections between the gateway device and the households.

A wide variety of other types of gateway devices may be utilized as desired in various embodiments of the disclosure. For example, a multi-dwelling unit (“MDU”) gateway device may be configured for use at an apartment complex or another multi-dwelling unit. An MDU device may include a gateway device that includes a suitable multi-band modem and, as desired, a suitable multi-tenant router.

Operational Overview

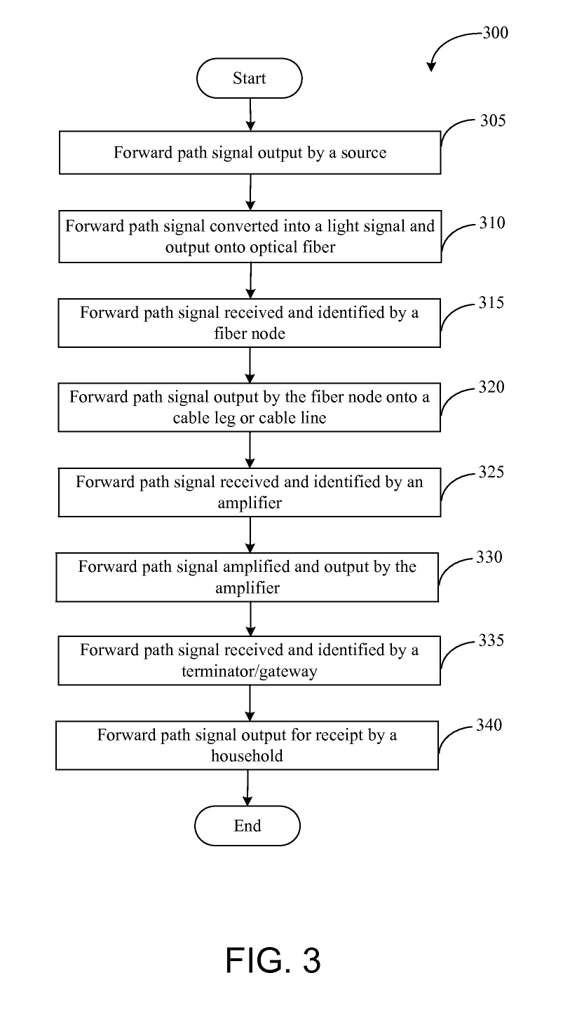

FIG. 3 is a flow diagram of an example method 300 for providing a broadband communication to a household, according to an illustrative embodiment of the disclosure. The method 300 illustrated in FIG. 3 is a method for providing a forward path or downstream signal to a household utilizing a suitable cable infrastructure or cable system, such as the system 100 illustrated in FIG. 1.

The method 300 may begin at block 305. At block 305, a forward path signal may be generated and output by a suitable signal source, such as the source 105 illustrated in FIG. 1. The forward path signal may be a broadband signal including any number of data components, such as television components, telephone components, etc. At block 310, the forward path signal may be converted into a light signal that may be output onto an optical fiber for transmission, such as the optical fiber 140 illustrated in FIG. 1. As desired, a suitable WDM system, such as the WDM system 145 shown in FIG. 1, may be utilized to process the forward path signal and output the forward path signal onto the optical fiber 140. The WDM system 145 may be a system that is capable of processing at least three different types of signals, including the forward path signal, a relatively low frequency return signal, and a relatively high frequency return signal.

The forward path signal may be communicated by the optical fiber 140 to a fiber node, such as the triplex fiber node 110 illustrated in FIG. 1. The fiber node 110 may receive the forward path signal at block 315, and the fiber node 110 may identify the forward path signal. For example, one or more filters associated with the fiber node 110, such as a band-pass filter, may be utilized to identify the forward path signal. The fiber node 110 may then convert the forward path signal into an RF signal and output the RF signal onto one or more cable legs or cable lines at block 320. For example, the forward path signal may be output by the fiber node 110 onto a cable line that is similar to the cable line 155 illustrated in FIG. 1. As desired, the fiber node 110 may amplify the forward path signal prior to outputting the forward path signal.

The cable line 155 may communicate the forward path signal to any number of terminators or taps, such as the terminator 120 illustrated in FIG. 1. At block 325, an amplifier positioned between the fiber node 110 and the terminator 120, such as the triplex amplifier 115 illustrated in FIG. 1, may receive and identify the forward path signal. For example, one or more filters associated with the amplifier 115, such as a band-pass filter, may be utilized to identify the forward path signal. Once the forward path signal has been identified and/or isolated, the amplifier 115 may amplify the forward path signal and output the forward path signal for downstream communication on the cable line 155 at block 330.

At block 335, the forward path signal may be received and identified by the terminator 120. For example, one or more filters associated with the terminator 120 may be utilized to identify and/or isolate the forward path signal. As desired, the terminator 120 may optionally amplify the forward path signal and output the forward path signal for downstream communication to one or more other terminators and/or amplifiers. Additionally, at block 340, the terminator 120 and/or a gateway device associated with the terminator 120 may output the signal for receipt by at least one household. In certain embodiments, the forward path signal may be output by the terminator 120 for receipt by a home or household gateway device. In other embodiments, a gateway device may be incorporated into the terminator 120, and the gateway device may receive the forward path signal and output at least a portion of the forward path signal for receipt by one or more household devices.

The method 300 may end following block 340.

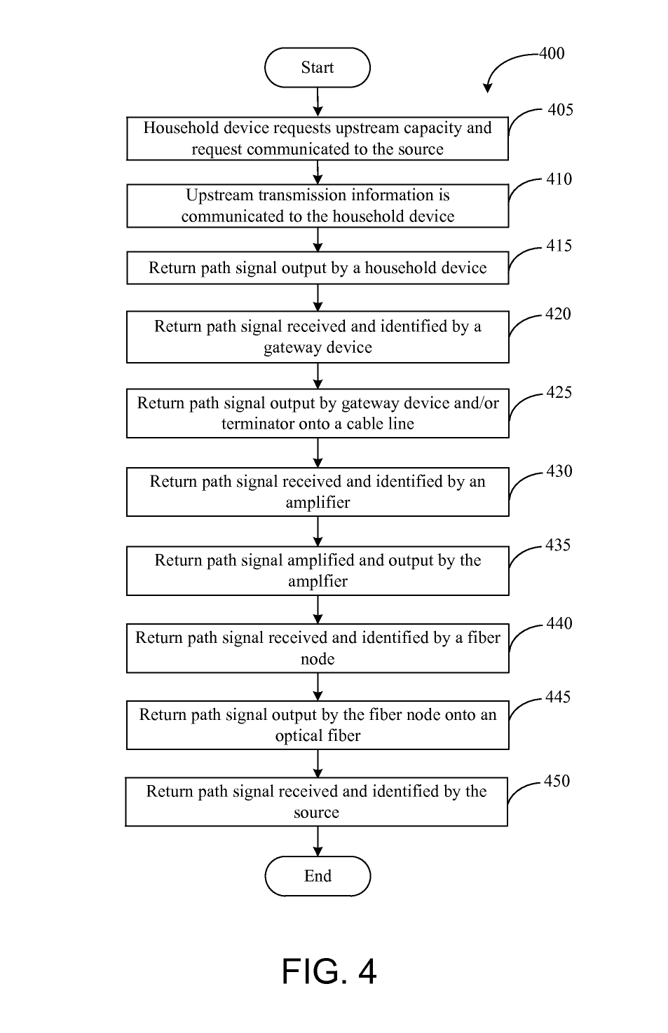

FIG. 4 is a flow diagram of an example method 400 for receiving a broadband communication from a household, according to an illustrative embodiment of the disclosure. The method 400 illustrated in FIG. 4 is a method for providing a return path or upstream signal to a household utilizing a suitable cable infrastructure or cable system, such as the system 100 illustrated in FIG. 1.

The method 400 may begin at block 405. At block 405, a household device (e.g., a set-top box, personal computer, modem, etc.) may request permission to communicate a return path or upstream signal to a source, such as the source 105 illustrated in FIG. 1. The request may indicate that an upstream communication is available and, as desired, a size or data capacity of the upstream communication. In certain embodiments, a certain amount of upstream capacity may be requested. The request may be communicated to the source 105 utilizing at least one return path. A wide variety of techniques or methods may be utilized to communicate the request to the source, such as the method described below with reference to blocks 415-450.

At block 410, the request may be received by the source 105, and the source 105 may communicate upstream transmission information to the household device that made the request. The upstream transmission information may specify the parameters under which the upstream communication will be output by the household device for communication to the source, including but not limited to, times or time periods in which upstream communications should be output, sizes or data amounts to be included in upstream communications, and/or frequencies and/or return path channels on which the upstream communications should be output. According to an aspect of the disclosure, the upstream transmission information may specify whether an upstream communication should be output by a household device on a relatively low frequency return path (e.g., a return path having a frequency between approximately 5 MHz and approximately 85 MHz) and/or on one or more relatively high frequency return paths (e.g., a return path having a frequency between approximately 1.1 GHz and approximately 1.8 GHz or higher). In certain embodiments, the upstream transmission information may be communicated to the household device using a suitable forward path or downstream path. For example, the upstream transmission information may be communicated to the household device in accordance with the method 300 described above with reference to FIG. 3.

At block 415, the upstream transmission information may be received by a household device, and an upstream or return path signal may be generated and/or formatted by the household device in accordance with the upstream transmission information. The return path signal may then be output by the household device for communication to the source 105.

At block 420, the return path signal may be received and identified by a suitable gateway device and/or terminator, such as the gateway devices 125, 130 and/or the terminator 120 illustrated in FIG. 1. The gateway device or terminator may identify the return path signal utilizing any number of suitable physical, hardware, and/or software filters. For example, a relatively low frequency return path signal that is output on a conventional return path may be identified utilizing one or more low pass filters. As another example, a relatively high frequency return path signal that is output on a return path having a frequency that is greater than the forward path may be identified utilizing one or more suitable high pass filters. Once the return path signal has been identified, the gateway device and/or terminator may output the return path signal at block 425 for upstream communication to the source 105. For example, the return path signal may be output onto or driven onto a suitable cable line, such as the cable line 155 illustrated in FIG. 1. As desired, the return path signal may be amplified prior to output.

At block 430, the return path signal may be received and identified by an amplifier, such as the triplex amplifier 115 illustrated in FIG. 1, that is connected to the cable line 155 and positioned between the gateway device/terminator and an upstream fiber node, such as the fiber node 110 illustrated in FIG. 1. The return path signal may be identified and/or isolated utilizing any number of suitable filters, such as low pass and/or high pass filters. Once the return path signal has been identified, the triplex amplifier 115 may amplify the return path signal and output the return path signal at block 435 for upstream communication.

At block 440, the return path signal may be received and identified by the fiber node 110. For example, the fiber node 110 may filter received signals to identify the return path or upstream signal utilizing filtering techniques that are similar to those described above. At block 445, the fiber node 110 and/or an associated WDM system may convert the received RF upstream signal into a light signal that may be output onto an optical fiber, such as the optical fiber 140 illustrated in FIG. 1. For example, one or more lasers may be utilized to output the signal onto an optical fiber 140. As desired, any number of wavelengths may be utilized to generate the upstream signal that is output onto the fiber 140. Additionally, in certain embodiments, different wavelength may be utilized for the return path signal depending on whether the signal is a relatively high frequency signal or a relatively low frequency signal.

At block 450, the return path signal may be received and identified by the source 105. For example, the return path signal may be received by a WDM system associated with the source, and the return path signal may be converted into an RF signal. The return path signal may be filtered out or isolated either prior to the conversion into an RF signal or following the conversion. The return path signal may then be processed by the source 105 as desired in various embodiments of the disclosure.

The method 400 may end following block 450.

The operations described and shown in the methods 300, 400 of FIGS. 3 and 4 may be carried out or performed in any suitable order as desired in various embodiments of the disclosure. Furthermore, in certain embodiments, less than or more than the operations described in FIGS. 3 and 4 may be performed.

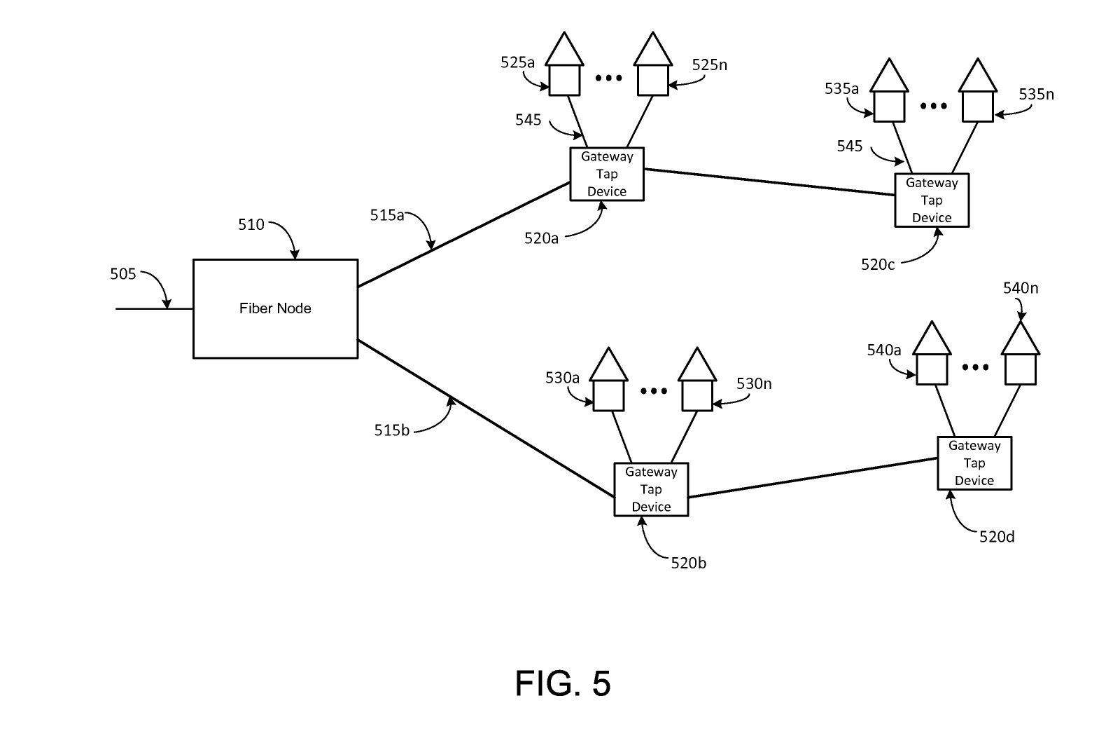

Referring now to FIG. 5, a system 500 for providing broadband communication using optical fibers is provided in accordance with one or more example embodiments. The system 500 may include an optical fiber distribution node 510, referred to hereinafter as a fiber node 510, which may be configured to receive a downstream signal (e.g., from a source component) via an input optical fiber 505. In addition, the fiber node 510 may be coupled to one or more gateway tap devices 520a-d via one or more output optical fibers 515a-b. It will be appreciated that any number of fiber nodes 510 may be in communication with any number of gateway tap devices 520a-d via any number of output optical fibers 515a-b. Furthermore, the respective gateway tap devices 520a-d may be configured to provide broadband service to any number of customer premises 525a-n, 530a-n, 535a-n, and 540a-n.

According to one or more embodiments, the fiber node 510 may be configured to transmit the received downstream signal to one or more output optical fibers 515a-b. For instance, the fiber node 510 may split the received downstream signal onto the output optical fibers 515a-b. As such, the downstream signal may be transmitted to gateway tap devices 520a and 520c via output optical fiber 515a. Similarly, the downstream signal may be transmitted to gateway tap devices 520b and 520d via output optical fiber 515b. In other words, the downstream signal may be delivered by using optical fibers all the way to the gateway tap devices 520a-d.

Additionally, the gateway tap devices 520a-d may be configured to convert the received downstream signal and convert the downstream signal in to a radio frequency downstream signal. The gateway tap device 520a-b may facilitate the operations of both a gateway and/or a tap/terminator. Furthermore, the gateway tap devices 520a-d may provide the radio frequency downstream signals to their respective customer premises (e.g., customer premises 525a-n, 530a-n, 535a-n, and 540 a-n). To this end, the radio frequency downstream signal may be provided to the customer premises using one or more cable lines 145. In certain implementations, the radio frequency downstream signal may be associated with a frequency band range of approximately 500 MHz to approximately 1650 MHz.

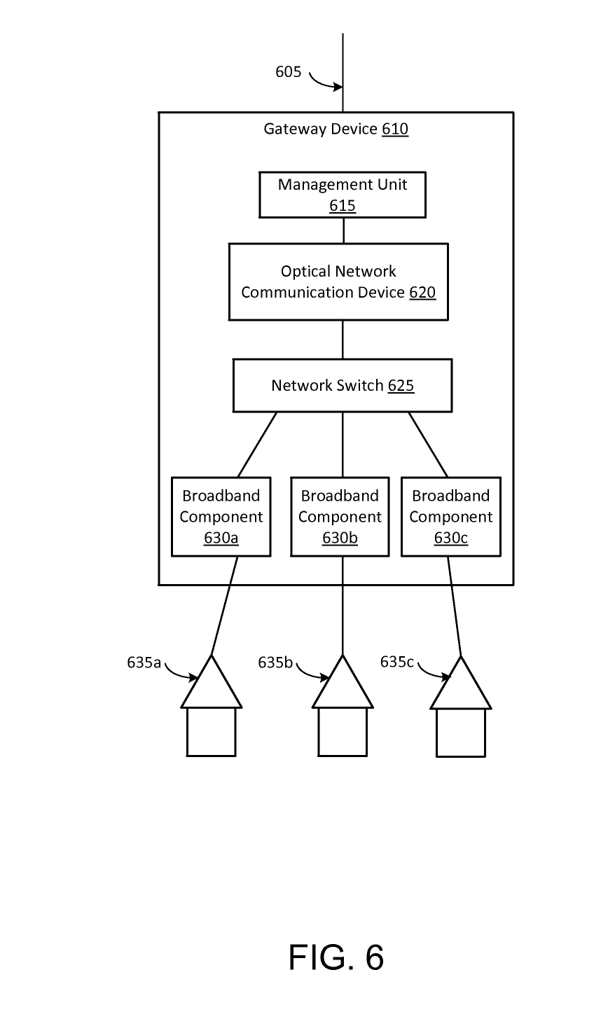

Referring now to FIG. 6, a block diagram 600 of a gateway device 610 is illustrated in accordance with one or more example embodiments. In certain implementations, the gateway device 610 may be a gateway tap device (e.g., the gateway tap device(s) 520a-b illustrated in FIG. 5). The gateway device 610 may include a management unit 615, an optical network communication device 620, a network switch 625, and/or one or more broadband components 630a-c.

According to one or more embodiments, the management unit 615 may be configured to receive, from a remote location, commands for activating and/or deactivating one or more operations of the gateway device 610 (e.g., operation of the optical network communication device 620). For instance, the management unit 615 may be in communication with a remote computer and/or any other remote device, such as via a network. As such, the remote computer may issue certain commands, and in response to the commands, the management unit 615 may activate and/or deactivate one or more operations and/or components of the gateway device 610.

The optical network communication device may be configured to receive light signals transmitted by an optical fiber 605. For instance, a downstream signal may be transmitted on the optical fiber, such as from a fiber node and/or source component. As such, the optical network communication device 320 may receive the downstream signal as a light signal. In some implementations, the optical network communication device 620 may be a passive optical network (PON) device (e.g., an Ethernet PON, Gigabit PON, and/or the like). Furthermore, the optical network communication device 620 may be configured to convert the downstream signal into a radio frequency downstream signal. The optical network communication device 602 may also be configured to transmit the radio frequency downstream signal to a network switch 625.

According to one or more embodiments, the network switch 625 may be configured to provide the radio frequency downstream signal to one or more broadband components 630a-c. For instance, the network switch 625 may split the radio frequency downstream signal and transmit the split signals to respective broadband components 630a-c. To this end, the broadband components 630a-c may be configured to transmit and/or otherwise provide the radio frequency downstream signal to respective customer premises 635a-c for broadband service. It will be appreciated that the gateway device 610 may include any number of broadband components 630a-c to provide broadband service to any number of customer premises 635a-c.

Furthermore, in some implementations, the optical network communication device 620 may be configured to convert the light signals (e.g., the downstream signal) into an Ethernet signal. Additionally, the network switch 625 may be an Ethernet switch configured to split the Ethernet signal into multiple Ethernet signals and transmit the split Ethernet signals to respective broadband components. In such implementations, the broadband components 630a-c may be MoCA interface devices that transmit the Ethernet signals to the respective customer premises 635a-c for broadband service. In yet other implementations, the broadband components 630a-c may be located at the customer premises 635a-c rather than included within the gateway device 610.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system, comprising:
an optical fiber node coupled to a source component and configured to:
receive, from the source component, a downstream light signal via at least one input optical fiber, and
transmit the downstream light signal to a plurality of output optical fibers; and
a tap device coupled to the optical fiber node via at least one output optical fiber of the plurality of output optical fibers, the tap device comprising an optical network communication device configured to:
receive the downstream light signal via the at least one output optical fiber,
convert the downstream light signal into a radio frequency downstream signal, and
transmit the radio frequency downstream signal to a plurality of cable lines, wherein the plurality of cable lines are coupled to one or more customer premises.

2. The system of claim 1, wherein the optical network communication device comprises a passive optical network device.

3. The system of claim 2, wherein the passive optical network device comprising at least one of an Ethernet passive optical network device or a Gigabit passive optical network device.

4. The system of claim 1, wherein the tap device further comprises a management unit configured to activate and deactivate the optical network communication device in response to instructions received from a remote device.

5. The system of claim 1, wherein the optical network communication device is configured to transmit the radio frequency downstream signal in a frequency band comprising a block of frequencies ranging from about 500 MHz to about 1650 MHz.

6. The system of claim 1, wherein the tap device further comprises:
a network switch configured to:
receive the radio frequency downstream signal from the optical network communication device, and
transmit the radio frequency downstream signal to a plurality of network communication paths; and
a plurality of broadband components configured to:
receive the radio frequency downstream signal via the plurality of network communication paths, and
transmit the radio frequency downstream signal to the one or more customer premises via the plurality of cable lines.

7. The system of claim 6, wherein the plurality of broadband components comprise a plurality of Multimedia over Coax Alliance (MoCA) interface devices.

8. The system of claim 6, wherein the network communication paths comprise Ethernet communication paths.

9. The system of claim 1, wherein the source component comprises a wavelength-division multiplexing device configured to:
convert radio frequency downstream signals into light signals output onto the at least one input optical fiber, and
convert received upstream signals into radio frequency signals.

10. A method, comprising:
receiving, by a gateway tap device from a fiber distribution node via at least one optical fiber, a downstream light signal;
converting, by the gateway device, the downstream light signal into a radio frequency downstream signal; and
transmitting, by the gateway tap device, the radio frequency downstream signal to one or more customer devices via a plurality of cable lines.

11. The method of claim 10, wherein the gateway tap device comprises a passive optical network (PON) communication device.

12. The method of claim 10, further comprising:
remotely activating and deactivating the gateway tap device via a management unit included in the gateway tap device.

13. The method of claim 10, further comprising:
transmitting, by the gateway tap device, the radio frequency downstream signal in a frequency band comprising a block of frequencies ranging from about 500 MHz to about 1650 MHz.

14. The method of claim 10. wherein the fiber distribution node is configured to:
split a source downstream light signal into a plurality of downstream light signals, and
transmit the plurality of downstream light signals to a plurality of gateway tap devices.

15. The system of claim 10, further comprising:
splitting, by a network switch, the radio frequency downstream signal into a plurality of radio frequency downstream signals,
transmitting, by the network switch, the plurality of radio frequency downstream signals to the one or more customer premises, wherein the gateway tap device comprises the network switch.

16. An apparatus, comprising:
an optical network communication device configured to:
receive, from a fiber distribution hub, a downstream light signal via at least one output optical fiber,
convert the downstream light signal into a radio frequency downstream signal, and
a network switch configured to:
receive the radio frequency downstream signal from the optical network communication device;
split the radio frequency downstream signal into a plurality of radio frequency downstream signals; and
transmit the plurality of radio frequency downstream signals to a plurality of broadband components, via plurality of cable lines.

17. The apparatus of claim 16, wherein the broadband components are located at respective customer premises.

18. The apparatus of claim 16, wherein the broadband components comprise one or more MoCA interface devices.

19. The apparatus of claim 16, wherein the optical network communication device is a passive optical network device.

20. The apparatus of claim 16, further comprising:
a management unit configured to activate and deactivate the optical network communication device in response to instructions received from a remote device.
